(19) United States
(12) Patent Application Publication
(10) Pub. No.: US 2017/0080585 A1
(43) Pub. Date: Mar. 23, 2017

(54) METAL SPRING RETURN

(71) Applicant: SHAVELOGIC, INC., Plano, TX (US)

(72) Inventors: John W. Griffin, Moultonborough, NH (US); Craig A. Provost, Boston, MA (US); William E. Tucker, Attleboro, MA (US); Aaron G. Cantrell, Northampton, MA (US)

(21) Appl. No.: 15/120,222

(22) PCT Filed: Mar. 13, 2015
(86) PCT No.: PCT/US15/20538

§ 371 Date: Aug. 19, 2016

Related U.S. Application Data
(60) Provisional application No. 61/968,689, filed on Mar. 21, 2014.

(51) Int. Cl. B26B 21/52; B26B 21/22

(52) U.S. Cl. CPC B26B 21/521; B26B 21/225

(57) ABSTRACT

A replaceable shaving assembly comprising a blade unit and an interface element configured to removeably connect the blade unit to a handle, on which the blade unit is pivotably mounted, the interface element comprising a return element configured to provide a return force between the blade unit and handle, the return element comprising a metal leaf spring.

### BACKGROUND

The invention relates to shaving systems having handles and replaceable blade units. Shaving systems often consist of a handle and a replaceable blade unit in which one or more blades are mounted in a plastic housing. Such shaving systems often include a pivoting attachment between the blade unit and handle, which allows the blade unit to maintain optimum contact with the surface being shaved. The pivoting attachment often includes a mechanism to provide resistance during shaving and return the blade unit to a neutral or “rest” position when it is not in contact with the user's skin.

### SUMMARY

Generally, the present disclosure pertains to shaving systems and to replaceable shaving assemblies for use in such systems. The systems include a flexible return element. The flexible return element is a metal leaf spring, which provides resistance and return forces that are often provided by a pusher and follower mechanism in prior art shaving systems.

In one aspect, the invention features a replaceable shaving assembly comprising a blade unit and an interface element configured to removeably connect the blade unit to a handle, on which the blade unit is pivotably mounted. The interface element comprises a return element configured to provide a return force between the blade unit and handle, the return element comprising a metal leaf spring. A pivot stop may be formed integrally with the blade unit.

Some implementations may include one or more of the following features. The return element may be configured to bias the blade unit towards a rest position with respect to a pivot axis that is generally parallel to a long axis of the blade unit. The return element may comprise a metal alloy. The return element may be formed from a sheet material having a thickness of from about 0.05 to 4.0 mm. The return element may be generally U-shaped. A base portion of the U-shape may be configured to engage a surface of the blade unit.

The interface element may comprise a substantially rigid portion defining a cavity configured to receive a distal end of the handle. The interface element may include receiving openings and the return element may include mounting tabs disposed in the receiving openings.

The return element may be configured to bend upon rotation of the blade unit toward an upper surface of the handle. The interface element may comprise pivot elements that may be configured to be received by corresponding elements on the blade unit.

In another aspect, the invention features a shaving system that comprises a handle having a distal end and a proximal end and a shaving assembly, mounted on the distal end of the handle. The shaving assembly includes an interface element configured to connect the blade unit to the handle, and a blade unit pivotably mounted on the interface element. The interface element comprises a return element configured to provide a return force between the blade unit and handle, the return element comprising a metal leaf spring.

Some implementations may include one or more of the following features. The return element may be configured to bias the blade unit towards a rest position with respect to a pivot axis that is generally parallel to a long axis of the blade unit. The return element may comprise a metal alloy. The return element may be formed from a sheet material having a thickness of from about 0.05 mm to 4.0 mm. The interface element may comprise a substantially rigid portion defining a cavity configured to receive a distal end of the handle. The interface element may include receiving openings and the return element may include mounting tabs disposed in the receiving openings. The return element may be generally U-shaped. A base portion of the U-shape may be configured to engage a surface of the blade unit. The return element may be configured to bend upon rotation of the blade unit toward an upper surface of the handle. The interface element may comprise pivot elements that are configured to be received by corresponding elements on the blade unit. A pivot stop may be formed integrally with the blade unit.

The invention also features methods of shaving. For example, in one aspect the invention features a method of shaving comprising contacting the skin with the blade unit of a shaving system that includes a handle having a distal end and a proximal end, and pivotably mounted on the handle, a replaceable shaving assembly that includes a blade unit and an interface element configured to removeably connect the blade unit to the handle. The interface element comprises a return element configured to provide a return force between the blade unit and handle, the return element comprising a metal leaf spring.

### DESCRIPTION OF THE DRAWINGS

FIG. 1 is a perspective view of a shaving assembly according to one embodiment that includes a blade unit, an interface element, and a return element.

FIG. 2 is a perspective view of the interface element/return element assembly shown in FIG. 1.

FIG. 3 is a perspective view of the underside of the assembly shown in FIG. 2.

FIG. 4 is an exploded view of the assembly shown in FIG. 3.

FIG. 5 is a plan view of the underside of the assembly shown in FIG. 3, with the attachment features in phantom.

FIG. 6 is a perspective view of the underside of an interface element/return element assembly according to another embodiment.

FIG. 7 is a sectional view of the assembly shown in FIG. 6 taken along line A.

FIG. 8 is a perspective view of a shaving assembly according to an alternate embodiment.

FIG. 9 is a perspective view of the interface/return element assembly shown in FIG. 8

FIG. 10 is section view of the assembly shown in FIG. 9 taken along line B.

FIG. 11 is a perspective view of the return element shown in FIG. 6.

FIG. 12 is a perspective view of the return element shown in FIG. 4.

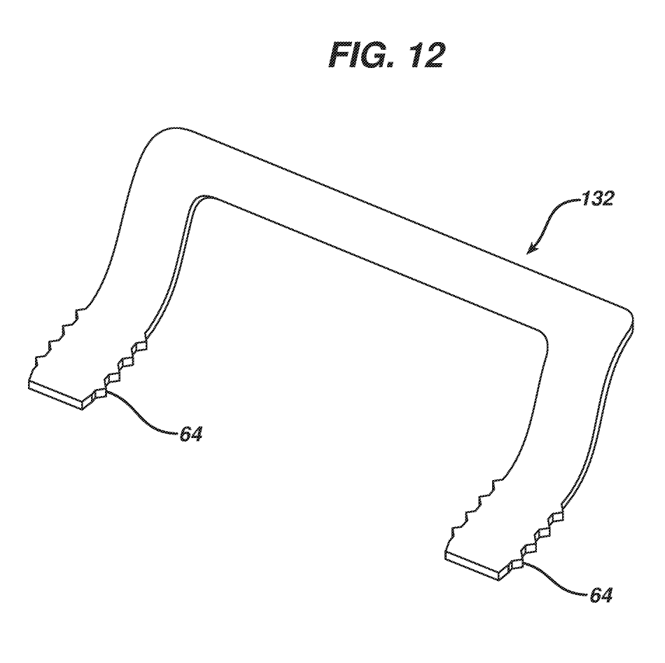

### DETAILED DESCRIPTION

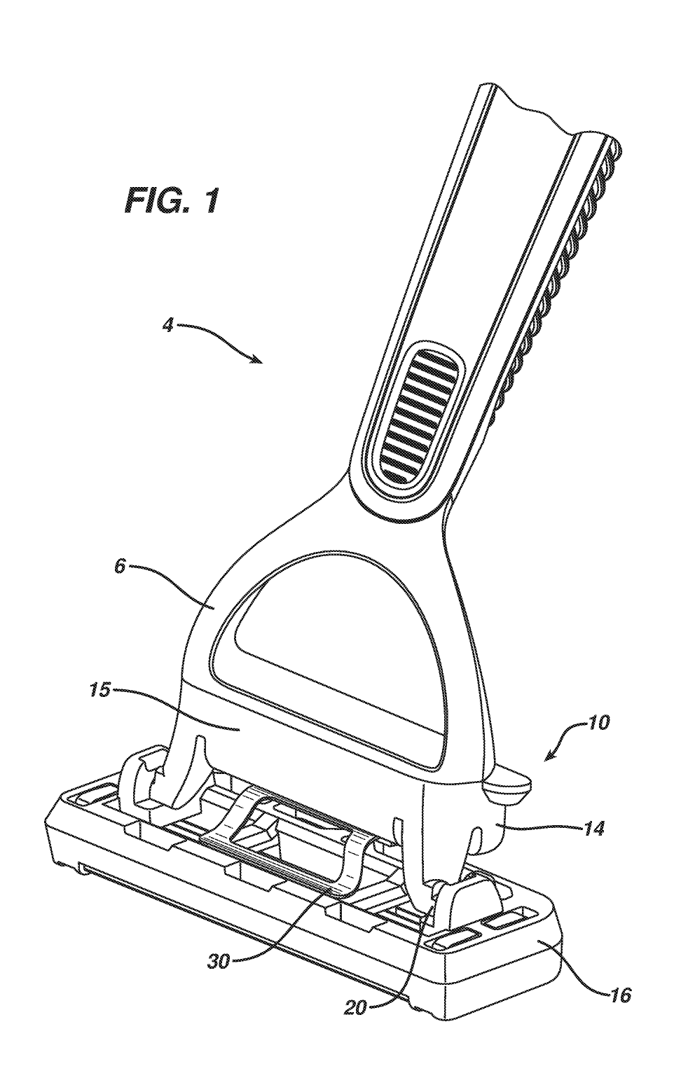

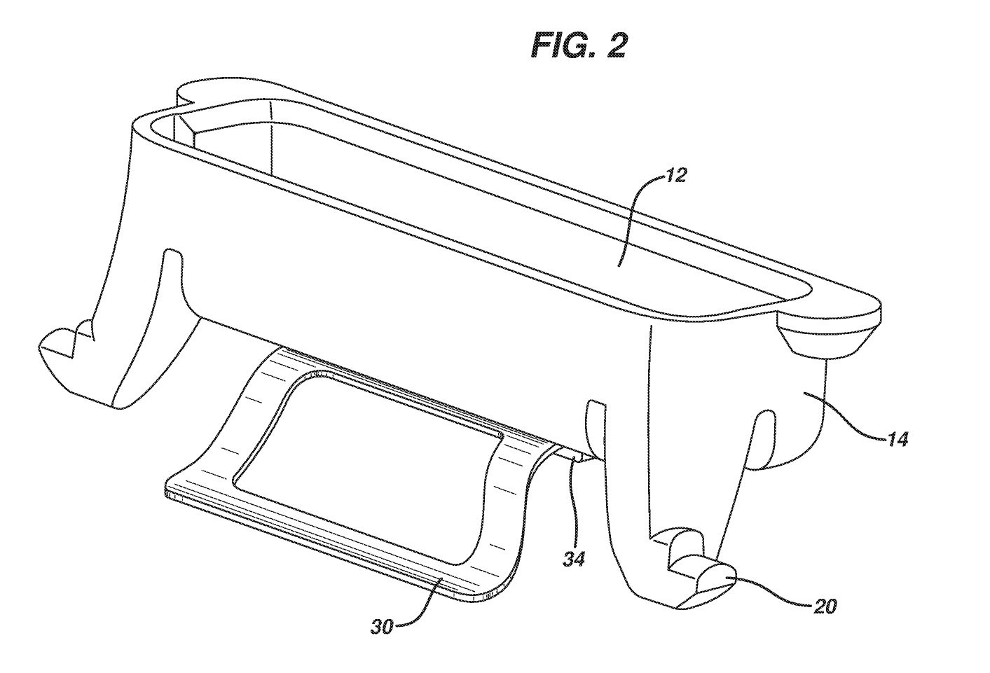

Shaving assemblies commonly include a handle and a replaceable blade unit. Referring to FIG. 1, a shaving system 4 includes a handle 6, an interface element 14, a return element 30, and a blade unit 16. Blade unit 16 includes a plurality of blades (not shown) and is pivotably mounted on the interface element. The interface element 14 includes a generally rigid body that defines a cavity 12 (FIG. 2) dimensioned to receive the distal end of handle 12. Generally, the interface element 14, the return element 30, and the blade unit 16 are sold to the consumer as an integrated, replaceable shaving assembly.

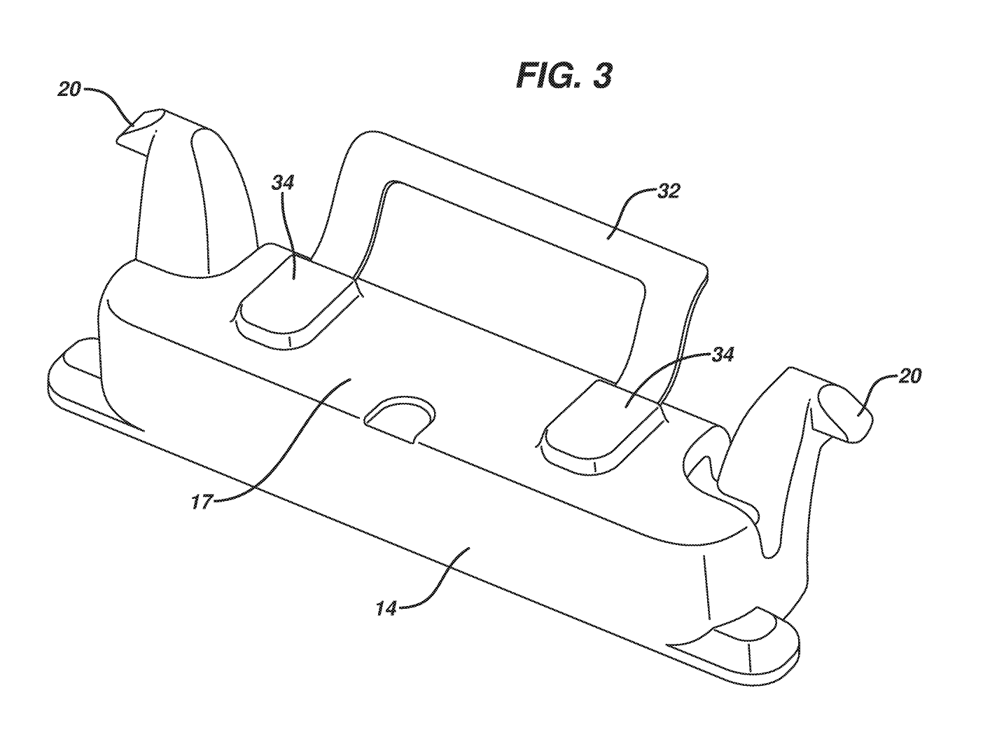

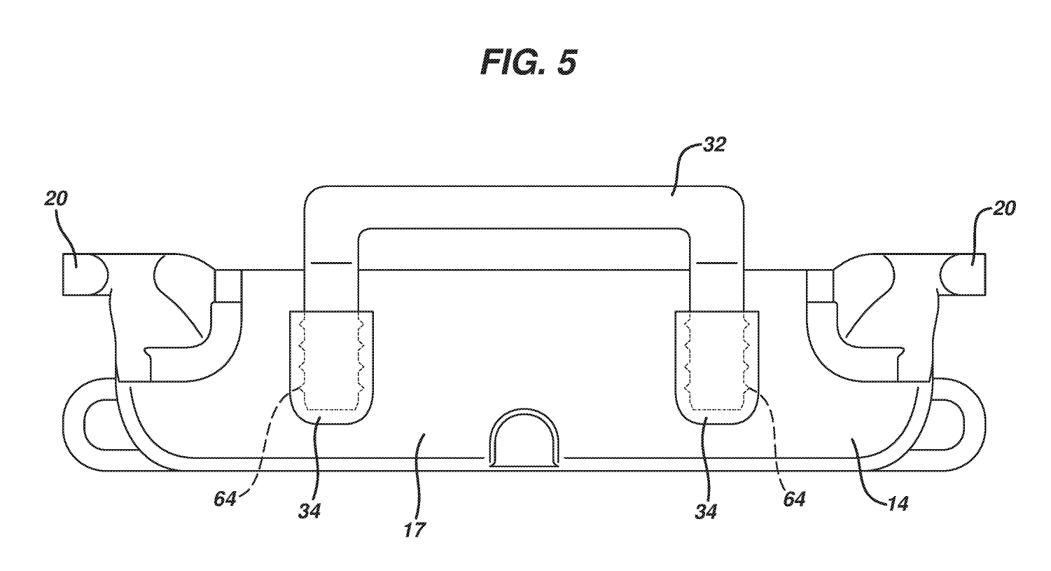

Referring to FIGS. 2 and 3, the return element 30 is mounted on interface element 14 and extends generally downwardly and outwardly from surface 17 of the interface element. The return element 32 includes a generally straight central portion 32 that is configured to engage the back surface of the blade unit (e.g., as shown in FIG. 1). The return element can be formed in a box shape as seen in FIG. 1. The box shape improves the torsional rigidity of the return element enhancing the manufacturability and assembly. Alternatively, the return element can be generally U-shaped, e.g. as shown in FIG. 5.

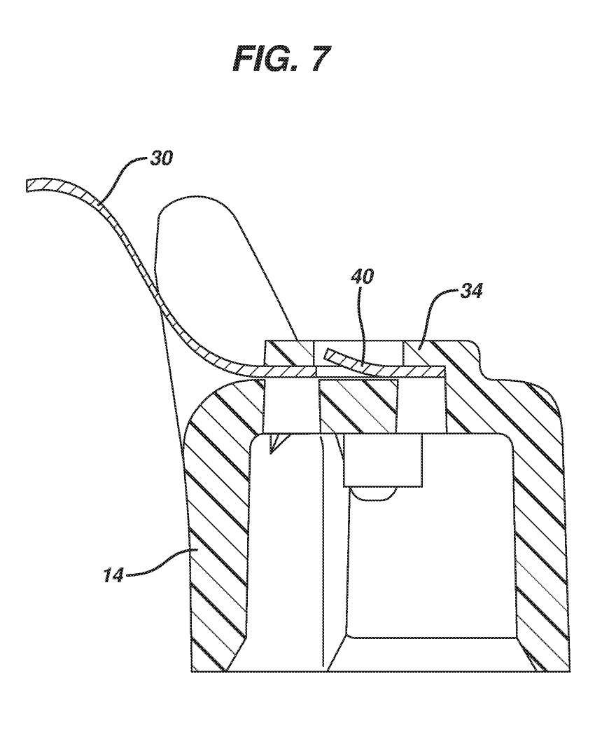

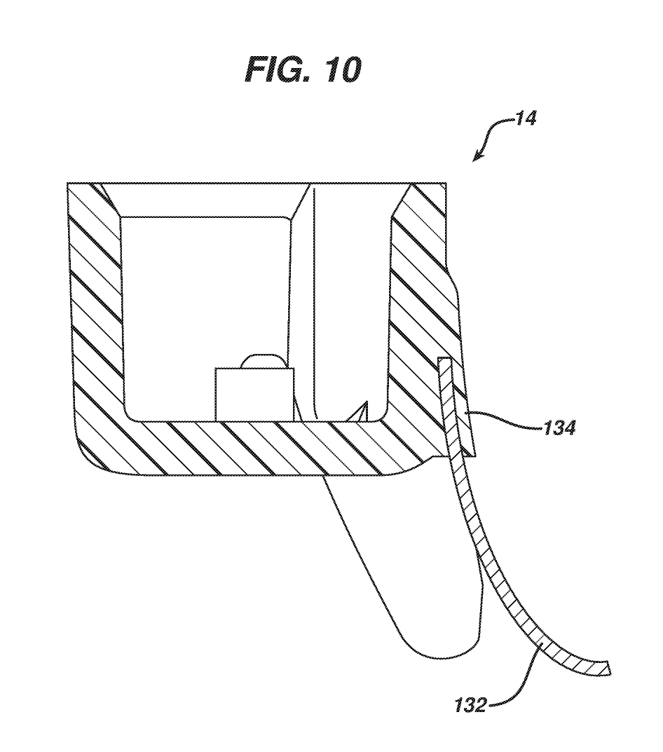

The return element may also have various shapes when seen from the side. For example, the side profile may define a single curve, as shown in FIG. 10, or a double-curved, “S” shape, as shown in FIG. 7. The latter shape may be used to move the return force further from the pivot point of the blade unit to better balance the blade unit during shaving. Other configurations and curve geometries are possible which provide acceptable flexing characteristics, functionality and ease of manufacturability and assembly.

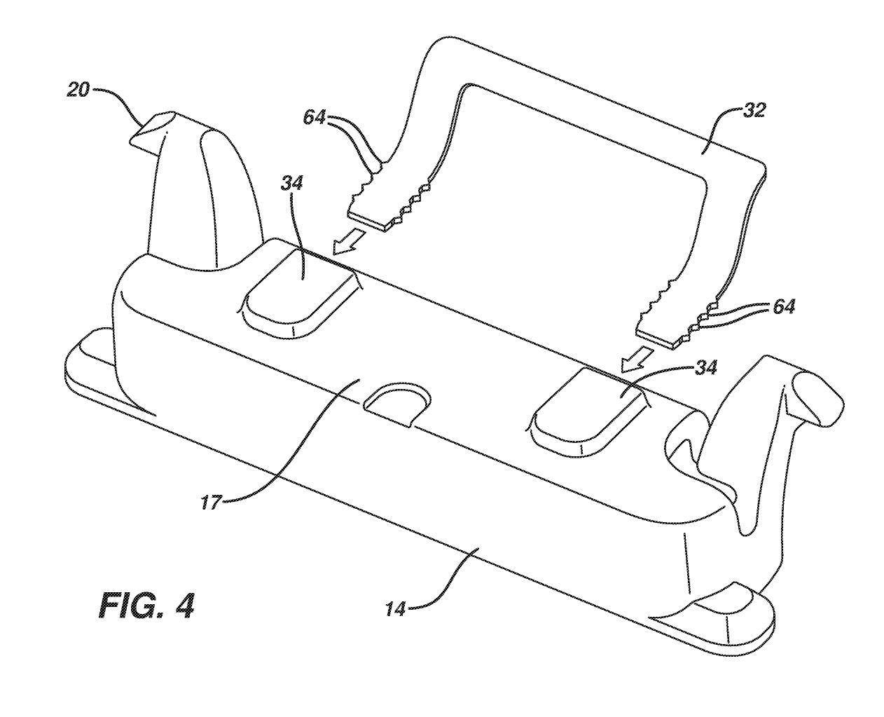

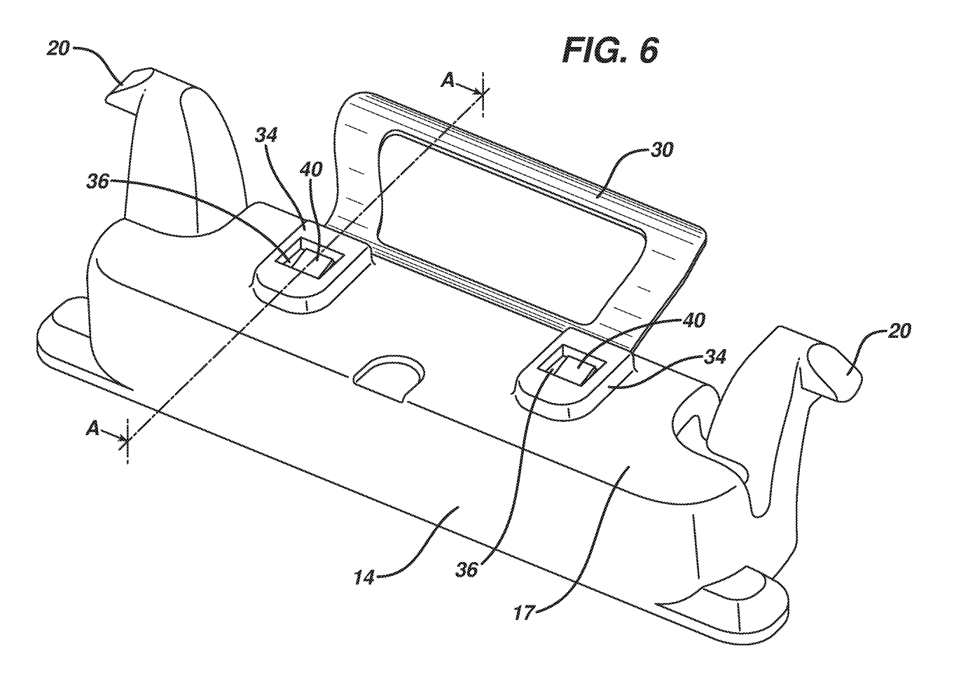

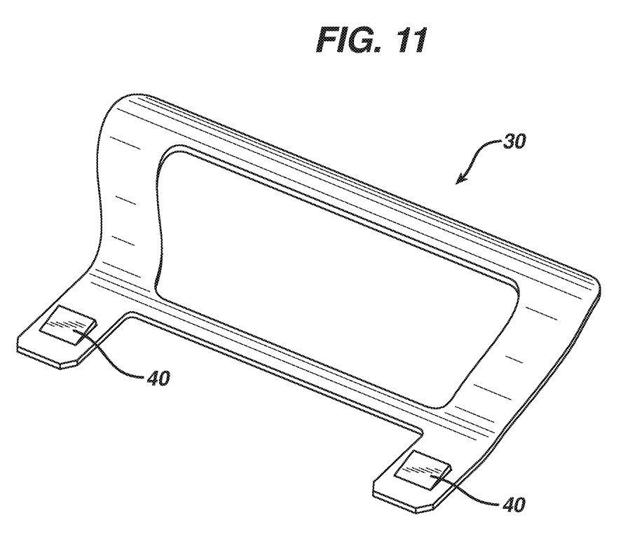

Referring to FIGS. 4 and 5, the return element 30 has a series of protrusions 64 which extend from its terminal aspects. The terminal aspects of the return element are configured to be received in complementary shaped recesses 34 on the bottom surface 17 of interface element 14. Protrusions 64 allow the return element to be easily and permanently affixed to the interface element 14. Alternate modes of affixing the return element to the interface element are possible. For example, referring to FIGS. 6, 7 and 11, tabs 40 could be configured at the terminal ends of the return element 30. Recesses 34 are configured with openings 36 which receive tabs 40, permanently affixing the return element 30 to the interface element 14.

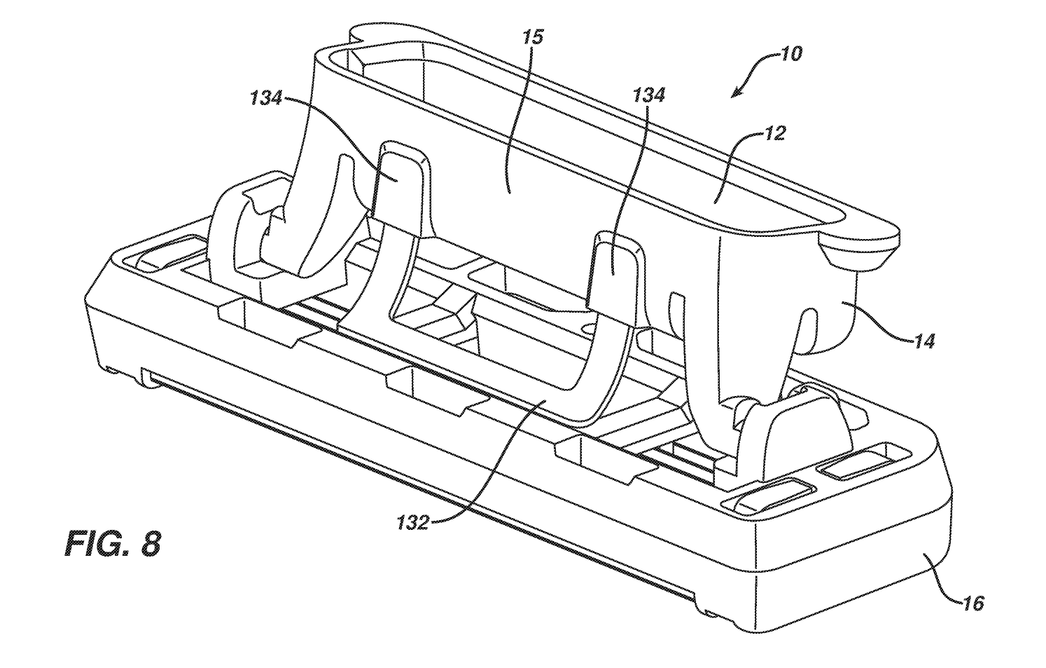

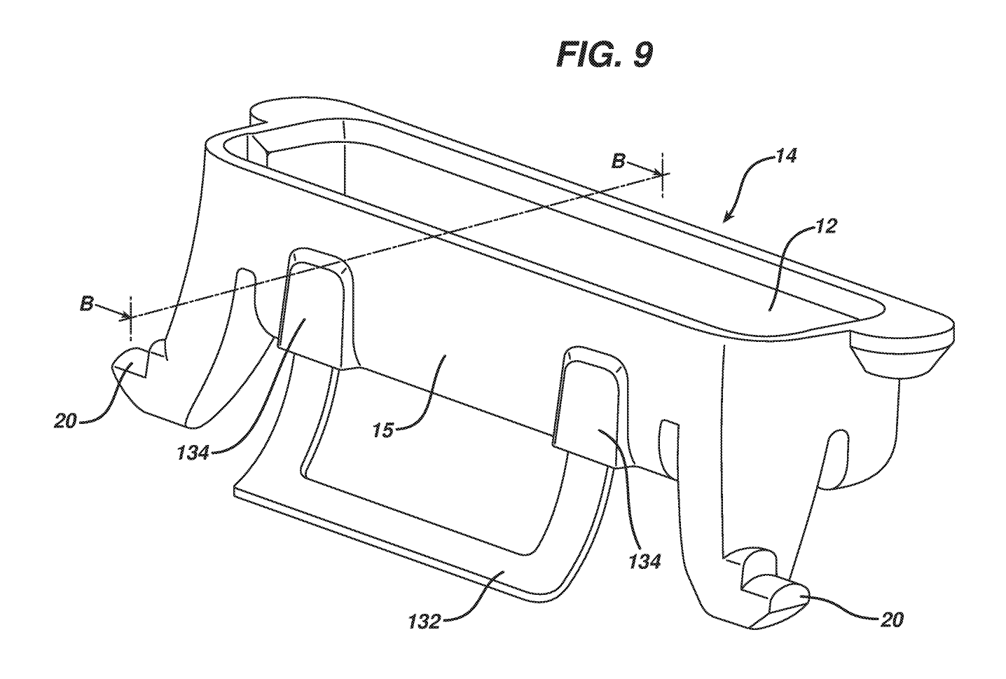

Referring to FIGS. 8, 9, and 10, complementary shaped recesses 134 are configured on front surface 15 of the interface element 14, rather than on bottom surface 17. This alternative configuration is designed to accommodate an alternatively shaped return element 132. Return element 132 may be attached to the interface element 14 in any of the manners previously discussed.

In all of the embodiments discussed herein, the return element is designed such that its geometry and other characteristics provide an applied load as assembled that is sufficient to overcome the friction of the system at rest (pretensioned load), typically at least 5 grams, e.g., 5 to 40 grams, and a load during shaving of from about 10 to 110 grams. Preferably, the return element is formed of a material that has a spring rate that provides a relatively high preload and a relatively low spring rate during shaving. The return element is preferably constructed of a metal alloy, e.g. stainless steel, carbon strip steel, nickel plated alloy, nickel chromium alloy, or other alloys, such that it resists corrosion and staining. The return element could be formed by stamping, metal injection molding or similar. In some implementations, the return element is formed of stainless steel, nickel-based alloy, high carbon strip, or similar. The return element may have a thickness of, e.g., from 0.05 to 4.0 mm. Advantageously, forming the return element from a metal alloy improves longevity and provides for a stable the spring rate that will not change with repeated use. This is due, in part, because the material is forgiving and offers consistent bending characteristics.

The interface element and handle can be formed, for example, from a non-elastomeric thermoplastic material such as acetyls (e.g., POM), polyvinyl chloride (PVC), high impact polystyrene (PS), polypropylene (PP), polyethylene (PE) (high and low density), ABS. Preferred materials have sufficient rigidity to provide the desired degree of lateral stability to the shaving assembly.

### OTHER EMBODIMENTS

A number of embodiments have been described. Nevertheless, it will be understood that various modifications may be made without departing from the spirit and scope of the disclosure.

For example, the return element can be dimensioned to provide for preferred flexing areas. In some implementations, the return element may include a notch, groove, weakened or strengthen cross-sectional region, or the like, to provide an area for preferential flexing.

Also, while removable shaving assemblies have been discussed above, in some implementations the shaving system is designed to be disposable as a whole. In these cases, the shaving assembly is affixed to the handle in a manner that is not intended for the consumer to remove, e.g., by fixedly mounting the interface element on the distal end of the handle. This may be accomplished, for example, by engagement of corresponding mechanical locking features on the handle and interface element, by welding (e.g., ultrasonic welding), by molding the interface element integrally with the handle, or by any other desired mounting technique.

In another embodiment, the return element may be affixed to the interface element in any suitable mechanical or chemical manner. For example, an adhesive may be used to join the elements into one unit or, an over-molding technique may be used to mold the interface element over the return element to form one unit.

Other embodiments may feature alternative mounting points for the return element. For example, the return element may be mounted to any surface or aspect of the interface element such that the desired functionality and manufacturability is achieved.

Accordingly, other embodiments are within the scope of the following claims.

What is claimed is:

1. A replaceable shaving assembly comprising:
a blade unit; and
an interface element configured to removeably connect the blade unit to a handle, on which the blade unit is pivotably mounted,
the interface element comprising a return element configured to provide a return force between the blade unit and handle, the return element comprising a metal leaf spring.

2. The shaving assembly of claim 1, wherein the return element is configured to bias the blade unit towards a rest position with respect to a pivot axis that is generally parallel to a long axis of the blade unit.

3. The shaving assembly of claim 1, wherein the return element comprises metal alloy.

4. The shaving assembly of claim 1, wherein the return element is formed from a sheet material having a thickness of from about 0.05 to 4.0 mm.

5. The shaving assembly of claims 1, wherein the interface element comprises a substantially rigid portion defining a cavity configured to receive a distal end of the handle.

6. The shaving assembly of claim 5, wherein the interface element includes receiving openings and the return element includes mounting tabs disposed in the receiving openings.

7. The shaving assembly of claim 1, wherein the return element is generally U-shaped.

8. The shaving assembly of claim 7, wherein a base portion of the U-shape is configured to engage a surface of the blade unit.

9. The shaving assembly of claim 1, wherein the return element is configured to bend upon rotation of the blade unit toward an upper surface of the handle.

10. The shaving assembly of claim 1, wherein the interface element comprises pivot elements that are configured to be received by corresponding elements on the blade unit.

11. The shaving assembly of claim 1 further comprising a pivot stop formed integrally with the blade unit.

12. A shaving system comprising:
a handle having a distal end and a proximal end; and
a shaving assembly, mounted on the distal end of the handle, the shaving assembly including an interface element configured to connect the blade unit to the handle, and a blade unit that is pivotably mounted on the interface element, the interface element comprising a return element configured to provide a return force between the blade unit and handle, the return element comprising a metal leaf spring.

13. The shaving assembly of claim 12, wherein the return element is configured to bias the blade unit towards a rest position with respect to a pivot axis that is generally parallel to a long axis of the blade unit.

14. The shaving assembly of claim 12, wherein the return element comprises metal alloy.

15. The shaving assembly of claim 12, wherein the return element is formed from a sheet material having a thickness of from about 0.05 mm to 4.0 mm

16. The shaving assembly of claims 12, wherein the interface element comprises a substantially rigid portion defining a cavity configured to receive a distal end of the handle.

17. The shaving assembly of claim 16, wherein the interface element includes receiving openings and the return element includes mounting tabs disposed in the receiving openings.

18. The shaving assembly of claim 12, wherein the return element is generally U-shaped.

19. The shaving assembly of claim 18, wherein a base portion of the U-shape is configured to engage a surface of the blade unit.

20. The shaving assembly of claim 12, wherein the return element is configured to bend upon rotation of the blade unit toward an upper surface of the handle.

21. The shaving assembly of claim 12, wherein the interface element comprises pivot elements that are configured to be received by corresponding elements on the blade unit.

22. The shaving assembly of claim 12 further comprising a pivot stop formed integrally with the blade unit.

23. A method of shaving comprising contacting the skin with the blade unit of a shaving system that includes (a) a handle having a distal end and a proximal end, and (b) pivotably mounted on the handle, a replaceable shaving assembly that includes a blade unit and an interface element configured to removeably connect the blade unit to the handle, the interface element comprising a return element configured to provide a return force between the blade unit and handle, the return element comprising a metal leaf spring.
